(19) United States
(12) Patent Application Publication
(10) Pub. No.: US 2019/0113171 A1
(43) Pub. Date: Apr. 18, 2019

(54) ELECTRONIC DEVICE AND DISTANCE ADJUSTMENT DEVICE

(71) Applicant: Lenovo (Beijing) Co., Ltd., Beijing (CN)

(72) Inventor: Xueyi ZHANG, Beijing (CN)

(21) Appl. No.: 16/126,115

(22) Filed: Sep. 10, 2018

(30) Foreign Application Priority Data
Sep. 8, 2017 (CN) 201710806027.3

(51) Int. Cl. F16M 11/04; G02B 7/12; F16H 19/04; F16H 25/20

(52) U.S. Cl. CPC F16M 11/045; F16H 25/20; F16H 19/04; G02B 7/12

(57) ABSTRACT

Disclosed is a distance adjustment device, comprising: a rotary wheel rotatable about an axis. The distance adjustment device also includes a first block and a second block coupled to the rotary wheel, wherein the first and second blocks are symmetrically arranged with respect to said axis, such that the first and second blocks pivotably move about said axis with rotation of the rotary wheel. In addition, the distance adjustment device includes a first connecting member and a second connecting member coupled to the first block and the second block respectively, the first and second connecting members comprising a first holder and a second holder configured to hold a first member and a second member respectively; wherein upon rotation of the rotary wheel, the first and second connecting members are configured to move relative to the first and second blocks respectively, so that the first and second holders linearly move relative to each other to adjust a separation distance between the first and second members. Also disclosed is an electronic device that includes the aforesaid distance adjustment device.

### CROSS-REFERENCES TO RELATED APPLICATIONS

This application claims priority of Chinese Patent Application No. 201710806027.3, filed on Sep. 8, 2017, the entire content of which is hereby incorporated by reference.

### FIELD OF THE DISCLOSURE

The present disclosure generally relates to the field of electronic device technology and, more particularly, relates to a distance adjustment device and an electronic device comprising the distance adjustment device.

### BACKGROUND

In some electronic devices, a distance adjustment structure is often provided for adjusting the distance between a functional member and a supporting member. For instance, in augmented reality glasses (AR glasses) and virtual reality glasses (VR glasses), a distance adjustment structure is generally provided for adjusting positions of two optical engines corresponding to two eyes in a glasses frame to adjust an inter-pupillary distance.

In the existing technologies, a distance adjustment structure generally employs a screw and nut mechanism or a gear and rack mechanism, in which the distance adjustment is achieved through rotating a lead screw or gear to drive the movement of a functional member. During the distance adjustment, when the lead screw or gear is rotated clockwise, the functional member will move in one direction (which may be referred to as a “positive direction”), while only until the lead screw or gear is rotated counterclockwise, the functional member will move in the other direction (which may be referred to as a “negative direction”).

In real applications, users may find much inconvenience caused by the above-discussed mechanisms. For example, at the beginning stage of adjusting the distance between functional members, a user has no way to predict in advance whether to rotate the lead screw or gear clockwise or counterclockwise to move the corresponding functional member in a desired direction, but rather needs to attempt to rotate it first before recognizing a correct rotational direction, which results in a strong possibility of mis-operation. If a nut is already at a maximum position of the lead screw (i.e., the end of the lead screw), or the gear is already at a maximum position of a rack (i.e., the end of the rack), the user, without knowing such positions, may still perform the attempted adjustment. Once such mis-operation occurs and with an excessive force, there is a strong possibility that the distance adjustment structure will be damaged. This results in a relatively high rate of damage to the distance adjustment structure.

The disclosed methods and systems are directed to solve one or more problems set forth above and other problems.

### BRIEF SUMMARY OF THE DISCLOSURE

A first aspect of the present disclosure is a distance adjustment device, comprising: a rotary wheel rotatable about an axis; a first block and a second block coupled to the rotary wheel, the first and second blocks being symmetrically arranged with respect to said axis, such that the first and second blocks pivotably move about said axis with rotation of the rotary wheel; a first connecting member and a second connecting member coupled to the first block and the second block respectively, the first and second connecting members comprising a first holder and a second holder configured to hold a first member and a second member respectively; wherein upon rotation of the rotary wheel, the first and second connecting members are configured to move relative to the first and second blocks respectively, so that the first and second holders linearly move relative to each other to adjust a separation distance between the first and second members.

A second aspect of the present disclosure is an electronic device comprising the aforesaid distance adjustment device.

Other aspects of the present disclosure can be understood by those skilled in the art in light of the description, the claims, and the drawings of the present disclosure.

### BRIEF DESCRIPTION OF THE DRAWINGS

To make the technical solutions in the embodiments of the present disclosure clearer, a brief introduction of the accompanying drawings consistent with descriptions of the embodiments will be provided hereinafter. It is to be understood that the following described drawings are merely some embodiments of the present disclosure. Based on the accompanying drawings and without creative efforts, persons of ordinary skill in the art may derive other drawings.

FIGS. 1A-1C illustrate different frontal views of one arrangement of a distance adjustment device consistent with the disclosed embodiments; and

FIG. 2 illustrates a vertical view of another arrangement of the distance adjustment device consistent with the disclosed embodiments.

### DETAILED DESCRIPTION

The present disclosure provides a distance adjustment device that does not cause user mis-operation and does not have maximum positions, which not only improves use effect of the distance adjustment device, but also reduces its chance of being damaged.

Reference will now be made in detail to example embodiments of the present disclosure, with reference to the accompanying drawings. The described embodiments are some, but not all, of the embodiments of the present disclosure. Based on the disclosed embodiments and without inventive efforts, persons of ordinary skill in the art may derive other embodiments consistent with the present disclosure, all of which are within the scope of the present disclosure.

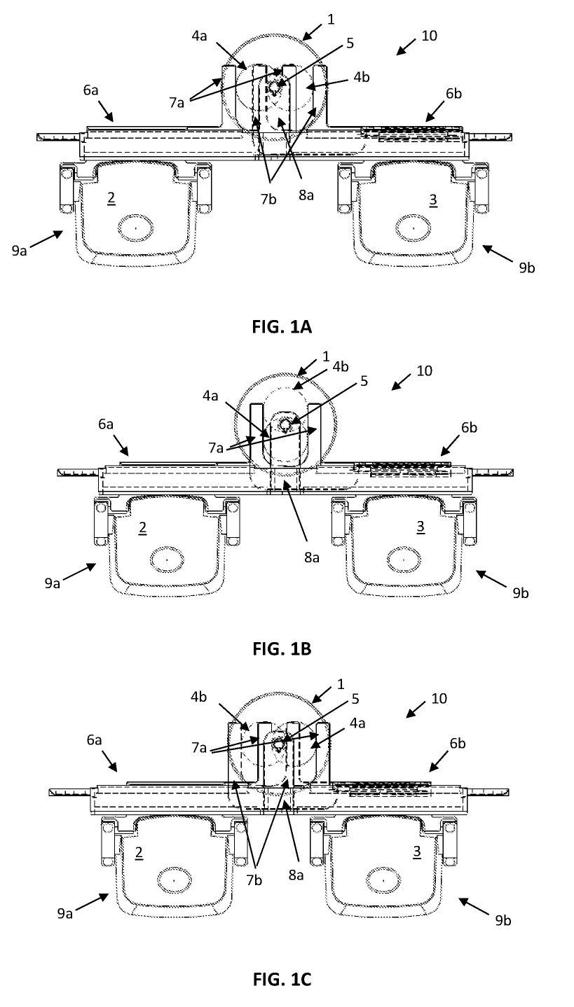

FIGS. 1A-1C show different frontal views of the distance adjustment device 10, which comprises: i) a rotary wheel 1 that is rotatable about an axis (shown as a central axis 5); ii) a first block and a second block (shown as a first cylindrical protruding block 4a and a second cylindrical protruding block 4b, respectively) that are symmetrically arranged, with respect to the axis 5, on opposite major surfaces of the rotary wheel 1; and iv) a first connecting member 6a and a second connecting member 6b coupled to the first and second protruding blocks 4a, 4b respectively.

Specifically, the first and second protruding blocks 4a, 4b are fixedly arranged and diametrically arranged to each other relative to respective opposite major surfaces of the rotary wheel 1 and the blocks 4a, 4b are pivotably coupled to the axis 5, such that the blocks 4a, 4b pivotably move relative to and about the axis 5 together with rotation of the rotary wheel 1. However, it can be envisaged that the first and second protruding blocks 4a, 4b may be arranged via any angles relative to each other relative to one or more opposite major surfaces of the rotary wheel 1, instead of being arranged diametrically opposite to each other as shown in FIGS. 1A-1C. It can also be envisaged that the first and second protruding blocks 4a, 4b may be arranged spaced from said opposite major surfaces of the rotary wheel 1. Such a variation can be realized if rotation of the rotary wheel 1 drives a synchronous rotation of the axis 5 which, in turn, drives rotation of the first and second protruding blocks 4a, 4b that are fixedly coupled to the axis 5. In addition, it can be envisaged that such a configuration will allow the first and second protruding blocks 4a, 4b to be arranged with respect to a same major surface of the rotary wheel 1, as long as the rotary wheel 1, the first protruding block 4a and the second protruding block 4b are spaced apart from one another.

Each of the first and second connecting members 6a, 6b comprises a coupling device, which is shown as connecting limbs 7a in the first connecting member 6a and as connecting limbs 7b in the second connecting member 6b. In particular, the connecting limbs 7a, 7b are configured to move relative to the corresponding first and second protruding blocks 4a, 4b upon rotation of the rotary wheel 1. Each of the first and second connecting members 6a, 6b further comprises a bar (which is shown via the reference numeral 8a in relation to the first connecting member 6a) that is coupled to the axis 5. The function of the bar is to ensure that the first and second connecting members 6a, 6b move linearly along a plane, upon rotation of the rotary wheel 1 which drives the relative motion between the connecting limbs 7a, 7b and the first and second protruding blocks 4a, 4b in a direction perpendicular to the direction along which the first and second connecting members 6a, 6b (more details will be provided below) move. The connecting limbs 7a, 7b may comprise gears that cooperatively actuate with corresponding gears of the first and second protruding blocks 4a, 4b to actuate the first and second connecting members 6a, 6b relative to the blocks 4a, 4b and in a direction perpendicular to the motion of the connecting members 6a, 6b upon rotation of the rotary wheel 1.

Further, each of the first and second connecting members 6a, 6b comprises a holder (shown as a first holder 9a for holding a first member 2 and a second holder 9b for holding a second member 3). Thus, unidirectional rotation of the rotary wheel 1 is translated into a linear motion of the first and second holders 9a, 9b along a plane and, accordingly, a separation distance between the first and second members 2, 3 mounted thereto along said plane. It should be understood that the aforesaid structure of the distance adjustment device 10 allows the first and second members 2, 3 to be brought nearer together and further apart with one complete revolution of the rotary wheel 1 (again, more details will be provided below). In the context of augmented reality (AR) and/or virtual reality (VR) devices, such as AR and/or VR glasses, the first member 2 and the second member 3 may be left and right optical engines in these glasses. By mounting or coupling the distance adjustment device 10 to these glasses, embodiments of the device 10 are then capable of adjusting a separation distance between the left and right optical engines, in order to satisfy different inter-pupillary distances of different users.

Next, operation of the distance adjustment device 10 will be described.

FIG. 1A shows an arrangement of the distance adjustment device 10 whereby the separation distance between the first and second holders 9a, 9b of the respective first and second connecting members 6a, 6b is the maximum. For instance, the maximum separation distance between the first and second holders 9a, 9b in this arrangement is 72 mm but the maximum separation distance may fall within a range of between 50-80 mm, or any other ranges.

When the rotary wheel 1 is rotated in an anti-clockwise direction by 90 degrees based on the frontal view of the distance adjustment device 10 shown in FIG. 1A, the first and second protruding blocks 4a, 4b move together to the respective positions as shown in FIG. 1B with the rotation of the rotary wheel 1 about the axis 5. Since the respective bars of the first and second connecting members 6a, 6b are coupled to the axis 5, rotation of the rotary wheel 1 accordingly drives the motion of the connecting limbs 7a, 7b relative to the first and second protruding blocks 4a, 4b in a (vertical) direction perpendicular to a (horizontal) direction along which the first and second holders 9a, 9b moves, which then causes the first and second holders 9a, 9b to move closer to each other along said (horizontal) direction. For instance, the separation distance between the first and second holders 9a, 9b at this arrangement is now shorter at 64 mm (72−8 mm). However, it should be appreciated that the separation distance at this arrangement can be modified using different dimensions of the rotary wheel 1, the first and second protruding blocks 4a, 4b, and so forth.

When the rotary wheel 1 is further rotated in the same anti-clockwise direction by a further 90 degrees to reach the arrangement as shown in FIG. 1C, the separation distance between the first and second holders 9a, 9b of the respective first and second connecting members 6a, 6b is now at its minimum. For instance, the minimum separation distance between the first and second holders 9a, 9b in this arrangement is 56 mm (64−8 mm) but the minimum separation distance may fall within a range of between 30-60 mm, or any other ranges.

Finally, when the rotary wheel 1 is rotated in the same anti-clockwise direction by a further 180 degrees to return back to the arrangement as shown in FIG. 1A, the structure of the distance adjustment device 10 as described above will move the first and second holders 9a, 9b further apart to reach the maximum distance (e.g. 72 mm). Therefore, the distance adjustment device 10 enables the first and second members 2, 3 to be brought nearer together and further apart with one complete rotation of the rotary wheel 1.

It should be understood that the rotary wheel 1 can be rotated in an opposite clockwise direction and the effect will be the same based on the application of the same mechanics.

Thus, according to the disclosed adjusting method, no matter which direction a user selects to rotate the rotary wheel 1, the objective of increasing and decreasing the distance between the first member 2 and the second member 3 can be achieved, and no mis-operation may occur. The user does not need to perform any trial operation, which may improve the use effect of the distance adjustment device. Additionally, as there are no structurally limiting positions in the rotational adjustment, even if the user performs the adjustment with an excessive force, the distance adjustment device will not be damaged. This may significantly reduce the chance of damaging the distance adjustment device and greatly improve the operational reliability of the distance adjustment device.

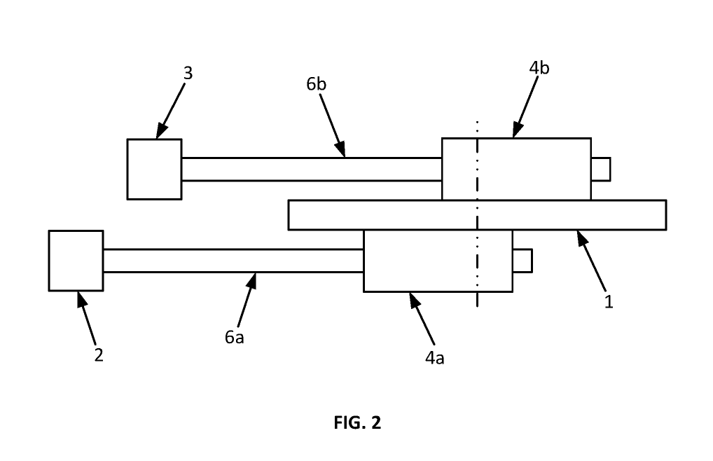

Alternatively, as shown in FIG. 2, the first member 2 and the second member 3 may be placed on the same side of the rotary wheel 1. However, this arrangement may require the connecting members to have sufficient lengths to satisfy the requirements of the distance adjustment between the first member 2 and the second member 3.

Specifically, the first member 2 and the first protruding block 4a, and the second member 3 and the second protruding block 4b may be respectively connected by the connecting member 6a and the connecting member 6b, as shown in FIG. 1 and FIG. 2. Without affecting general operations, the first member 2 and the second member 3 may directly connect to the rotary wheel 1. However, in order to allow a greater distance adjustment range in the disclosed embodiments, and also to avoid accidental interference between different members due to the compact space, the connecting members 6a and 6b are employed to connect the first member 2 or the second member 3 with the rotary wheel 1, to further improve the adjustment effect and operational reliability.

As shown in FIG. 1, in certain embodiments, the protruding blocks may be cylindrical protruding blocks, and one end of a connecting member (e.g., the connecting member 6a or the connecting member 6b) may be fixedly connected with the first member 2 or the second member 3, while the other end may include connecting limbs 7a or 7b for holding the first protruding block 4a or the second protruding block 4b. The circumferential edge of the first protrusion block 4a or the second protrusion block 4b may be in contact with the connecting limbs 7a or 7b, and the protruding block 4a or 4b may rotate and move within the connecting limbs 7a or 7b to drive the connecting members 6a, 6b to translate. That is, for the connecting member 6a connecting the first member 2 and the rotary wheel 1, one end may be fixedly connected with the first member 2, while the connecting limbs on the other end may be connected with the first protruding block 4a. The first protruding block 4a may be inserted into the connecting limbs, with the circumferential edge of the cylindrical first protruding block 4a in contact with the connecting limbs. The first protruding block 4a may rotate within the connecting limbs and also move in a direction perpendicular to a linear track of the first member 2 and the second member 3. For instance, when the first member 2 and the second member 3 move horizontally as illustrated in FIG. 1, the first protruding block 4a may move vertically within the connecting limbs, ensuring general translations of the first member 2 and the second member 3. The connecting member 6b connecting the second member 3 and the rotary wheel 1 may be similarly arranged. The above arrangement may be optimal to ensure that the first member 2 and the second member 3 move smoothly on a linear track.

In certain embodiments, other structures may be applied to the connecting members 6a, 6b. For example, the connecting member 6a or 6b may be a connecting rod that rotationally connects with the first member 2 or the second member 3 on one end, and rotationally connects with the first protruding block 4a or the second protruding block 4b on the other end. That is, the connecting members 6a, 6b may hingedly connect with both the first member 2 and the rotary wheel 1 or the second member 3 and the rotary wheel 1, respectively. This arrangement may also drive the first member 2 and the second member 3 to translate by rotating the rotary wheel 1 and, thus, is also considered as one of the candidate arrangements in the disclosed embodiments.

In certain embodiments, an electronic device comprising a supporting member and a distance adjusting device disposed on the supporting member is further provided. The distance adjustment device may include a similar structure as described in the above-disclosed embodiments. For instance, the electronic device may be a pair of AR glasses or VR glasses that includes a distance adjustment device 10 as shown in FIG. 1 to adjust the distance between two optical engines. Each optical engine may correspond to one of the first member 2 and the second member 3. The distance adjustment device may similarly include a rotary wheel 1, a first protruding block 4a, a second protruding block 4b, a connecting member 6a and a connecting member 6b that work together to adjust the distance between the two optical engines of the VR glasses or AR glasses, or other similar elements in other electronic devices.

The present disclosure has described each component of the overall structure in a progressive manner. The description of each component focuses on illustrating differences from an existing structure. The overall and partial structure of an electronic device and its incorporated distance adjustment device may be obtained by combining one or more of the above-described components.

In the disclosed distance adjustment device, the distance between different members can be adjusted by rotating the rotary wheel in a single direction (clockwise or counterclockwise) to enable the first member and the second member to linearly reciprocate. During the adjustment, the first connecting point connecting the first member with the rotary wheel and the second connecting point connecting the second member with the rotary wheel are respectively located at different eccentric positions of the first end surface and the second end surface of the rotary wheel. That is, the first connecting point and the second connecting point are axially staggered on the rotary wheel. This arrangement leads to the movements of the first member and the second member not synchronized (i.e., at different moving directions, moving speeds, etc.). Additionally, as the trajectory of the first member is in parallel with or superposes the trajectory of the second member and their movements are reciprocating movements, periodic changes of the distance between the first member and the second member can be eventually accomplished. In the above-described adjustment process, since it is the unidirectional rotation of the rotary wheel that causes the periodic changes of the distance between the first member and the second member, a user's objective of increasing or decreasing the distance can be accomplished regardless of the direction to be selected by the user in rotating the wheel. No mis-operation will occur, which improves use effect of the distance adjustment device. Additionally, as there are no limiting positions in such rotational adjustment, a chance of damage to the distance adjustment device has also been significantly reduced.

Since an electronic device incorporates the distance adjustment device of the above-disclosed embodiments, beneficial effects of the electronic device incorporating the distance adjustment device may refer to corresponding portions of the above-disclosed embodiments, which will not be repeated here.

The foregoing description of the disclosed embodiments enables those skilled in the art to implement or use the present disclosure. Various modifications and alterations to these embodiments may be apparent to those skilled in the art, and the general principle defined in the present disclosure could be implemented in other embodiments without departing from the spirit or scope of the present disclosure. Therefore, the present disclosure will not be limited to the disclosed embodiments, but conforms to the broadest scope consistent with the principle and novel features disclosed herein.

What is claimed is:

1. A distance adjustment device, comprising:
a rotary wheel rotatable about an axis;
a first block and a second block coupled to the rotary wheel, the first and second blocks being symmetrically arranged with respect to said axis, such that the first and second blocks pivotably move about said axis with rotation of the rotary wheel; and
a first connecting member and a second connecting member coupled to the first block and the second block respectively, the first and second connecting members comprising a first holder and a second holder configured to hold a first member and a second member respectively;
wherein upon rotation of the rotary wheel, the first and second connecting members are configured to move relative to the first and second blocks respectively, so that the first and second holders linearly move relative to each other to adjust a separation distance between the first and second members.

2. The distance adjustment device of claim 1, wherein the first and second blocks are arranged on opposite major surfaces of the rotary wheel and the first and second blocks pivotably move with respect to said axis with the rotation of the rotary wheel.

3. The distance adjustment device of claim 1, wherein the first and second blocks are diametrically arranged opposite to each other relative to one or more major surfaces of the rotary wheel.

4. The distance adjustment device of claim 1, wherein both the first and second blocks are arranged on a common major surface of the rotary wheel.

5. The distance adjustment device of claim 1, wherein the rotary wheel, the first block and the second block are arranged spaced apart from one another.

6. The distance adjustment device of claim 1, wherein the first and second connecting members comprise connecting limbs that couple to the first and second blocks respectively.

7. The distance adjustment device of claim 6, wherein the connecting limbs of each of the first and second connecting members comprises a gear that is operable to actuate with a corresponding gear of each of the first and second blocks to allow relative motion between the first and second connecting members and the respective first and second blocks upon rotation of the rotary wheel.

8. The distance adjustment device of claim 7, wherein said relative motion between the first and second connecting members and the respective first and second blocks is a direction perpendicular to a direction of motion of the first and second holders.

9. The distance adjustment device of claim 1, wherein each of the first and second connecting members further comprises a bar that is coupled to said axis, to control motion of the first and second connecting members upon rotation of the rotary wheel.

10. An electronic device, comprising:
a frame; and
a distance adjustment device coupled to the frame, wherein the distance adjustment device comprises:
a rotary wheel rotatable about an axis;
a first block and a second block coupled to the rotary wheel, the first and second blocks being symmetrically arranged with respect to said axis, such that the first and second blocks pivotably move about said axis with rotation of the rotary wheel; and
a first connecting member and a second connecting member coupled to the first block and the second block respectively, the first and second connecting members comprising a first holder and a second holder configured to hold a first member and a second member respectively;
wherein upon rotation of the rotary wheel, the first and second connecting members are configured to move relative to the first and second blocks respectively, so that the first and second holders linearly move relative to each other to adjust a separation distance between the first and second members.

11. The electronic device of claim 10, wherein the first and second members are optical engines of an augmented reality (AR) device or a virtual reality (VR) device.

12. The electronic device of claim 10, wherein said electronic device is an AR device or a VR device.
